(19) United States
(12) Patent Application Publication
(10) Pub. No.: US 2021/0292492 A1
(43) Pub. Date: Sep. 23, 2021

(54) METHOD FOR MANUFACTURING MODIFIED CELLULOSE FIBER BLENDED RESIN COMPOSITION

(71) Applicant: SEIKO PMC CORPORATION, Tokyo (JP)

(72) Inventors: Tomoaki YOSHIMURA, Chiba (JP); Shuhei YAMADA, Chiba (JP); Takashi KAWABATA, Chiba (JP); Ryuzaburo NAKAGIRI, Chiba (JP); Yuya TERAO, Chiba (JP)

(73) Assignee: SEIKO PMC CORPORATION, Tokyo (JP)

(21) Appl. No.: 17/258,444

(22) PCT Filed: Jan. 17, 2020
(86) PCT No.: PCT/JP2020/001506

§ 371 Date: Jan. 7, 2021

(30) Foreign Application Priority Data
Jan. 21, 2019 (JP) 2019-007710

(51) Int. Cl. C08J 5/06; C08L 23/06; C08J 3/22

(52) U.S. Cl. CPC C08J 5/06; C08L 23/06; C08J 2323/06; C08J 2401/02; C08J 2451/04; C08J 3/22

(57) ABSTRACT

The purpose of the present invention is to manufacture a bright-hued modified cellulose fiber blended resin composition more easily than before while utilizing a method of defibrillating a cellulose fiber and uniformly dispersing a cellulose nanofiber in a resin. A method for manufacturing the modified cellulose fiber blended resin composition includes: (i) a step of adding 5 to 45 parts by mass of water with respect to 100 parts by mass of a modified cellulose fiber (A) modified with a hydrophobizing agent (a) to obtain a hydrous cellulose fiber (A′); and (ii) a step of defibrillating the modified cellulose fiber while kneading the hydrous cellulose fiber (A′) with a thermoplastic resin and/or a rubber (B), and removing the water to attain a water content ratio of 1% or less after kneading.

### BACKGROUND

### Technical Field

The present invention relates to a method for manufacturing a modified cellulose fiber blended resin composition.

### Related Art

Conventionally, a carbon fiber, a glass fiber and the like are widely and generally used as reinforcing materials used for resins for molding materials. However, because the carbon fiber is hard to burn, the carbon fiber is not suitable for thermal recycling and is expensive. In addition, although the glass fiber is relatively inexpensive, there is a problem in disposal in thermal recycling.

On the other hand, a plant fiber is easy to perform thermal recycling which is difficult for an inorganic fiber and the carbon fiber, and thus the plant fiber attracts attention as an environmentally friendly material. For example, in Patent literature 1, it is confirmed that a material strength can be increased by blending the plant fiber with a resin material as compared with the resin alone.

In recent years, an application of a cellulose nanofiber which can further increase the material strength and is obtained by disentangling a plant fiber to a nano order is actively promoted. However, because the cellulose nanofiber is extremely hydrophilic and is not compatible with a hydrophobic resin, various studies are conducted on dispersion methods of the cellulose nanofiber.

Among the methods, as a method which is particularly industrially beneficial, a method as described in Patent literature 2 has been developed for chemically modifying the plant fiber with a hydrophobizing agent, defibrillating the plant fiber while kneading and blending the plant fiber with a resin, and uniformly dispersing the cellulose nanofiber in the resin.

### LITERATURE OF RELATED ART

### Patent Literature

Patent literature 1: Japanese Patent Laid-Open No. 2015-209439
Patent literature 2: Japanese Patent Laid-Open No. 2017-025338

### SUMMARY

### Problems to be Solved

However, in the method of Patent literature 2, in order to uniformly disperse the cellulose fiber in the resin while the cellulose fiber is defibrillated, it is necessary to finely adjust the blended amount and the kneading condition, and a simpler manufacturing method is desired. In addition, according to the raw material used and the kneading condition, a deterioration of color such as discoloration of a product or the like occurs before the cellulose fiber is sufficiently defibrillated and uniformly dispersed, and thus there is a problem that the product cannot be used in applications.

An object of the present invention is to manufacture bright-hued modified cellulose fiber blended resin composition more easily than before while utilizing a method of defibrillating a cellulose fiber and uniformly dispersing modified cellulose fiber in a resin.

### Means to Solve Problems

That is, the present invention is:

<1> A method for manufacturing a modified cellulose fiber blended resin composition, including: (i) a step of adding 5 to 45 parts by mass of water with respect to 100 parts by mass of a cellulose fiber (A) modified with a hydrophobizing agent (a) to obtain a hydrous cellulose fiber (A′); and (ii) a step of defibrillating the modified cellulose fiber while kneading the hydrous cellulose fiber (A′) with a thermoplastic resin and/or a rubber (B), and removing the water to attain a water content ratio of 1% or less after kneading.
<2> The method for manufacturing a modified cellulose fiber blended resin composition according to <1>, wherein the cellulose fiber (A) modified with the hydrophobizing agent (a) in which a fixing rate of the hydrophobizing agent (a) to the cellulose fiber is 5 to 50 mass % with respect to the cellulose fiber is used.
<3> The method for manufacturing a modified cellulose fiber blended resin composition according to <1> or <2>, wherein the hydrophobizing agent (a) is at least one type selected from acid anhydrides and derivatives thereof.
<4> The method for manufacturing a modified cellulose fiber blended resin composition according to any one of <1> to <3>, wherein the hydrous cellulose fiber (A′) and the thermoplastic resin and/or the rubber (B) are blended in a manner that a mass ratio is (A′)/(B)=105 to 145/100 to 250.
<5> The method for manufacturing a modified cellulose fiber blended resin composition according to any one of <1> to <4>, wherein the thermoplastic resin and/or the rubber (B) is at least one type selected from polyethylene resin, polypropylene resin, polystyrene resin, ethylene-vinyl acetate resin, and ethylene-propylene-diene rubber.
<6> The method for manufacturing a modified cellulose fiber blended resin composition according to any one of <1> to <5>, wherein the cellulose fiber (A) modified with the hydrophobizing agent (a) is defibrillated to a nanofiber in Step (ii).

### Effect

According to the manufacturing method of the present invention, a modified cellulose fiber blended resin composition which is bright-hued can be manufactured under an operation condition easier than before.

### DESCRIPTION OF THE EMBODIMENTS

A manufacturing method of the present invention includes: (i) a step of adding 5 to 45 parts by mass of water with respect to 100 parts by mass of a cellulose fiber (A) modified with a hydrophobizing agent (a) to obtain a hydrous cellulose fiber (A′) (hereinafter, sometimes referred to as “Step (i)”); and (ii) a step of defibrillating the modified cellulose fiber while kneading the hydrous cellulose fiber (A′) with a thermoplastic resin and/or a rubber (B), and removing the water to attain a water content ratio of 1% or less after kneading (hereinafter, sometimes referred to as “Step (ii)”).

<Cellulose Fiber (A) Modified with Hydrophobizing Agent (a)>

The cellulose fiber (A) modified with the hydrophobizing agent (a) is obtained by fixing the hydrophobizing agent (a) to a hydroxyl group of the cellulose fiber by a chemical bond (hereinafter, sometimes simply referred to as modified cellulose fiber (A)). By replacing the hydroxyl group of the cellulose fiber with the hydrophobizing agent (a), hydrogen bonding between the cellulose fibers is inhibited, and the cellulose fiber can be easily defibrillated when kneaded with the resin.

A raw material used to obtain the cellulose fiber may be a plant-derived fiber contained in wood, bamboo, hemp, jute, kenaf, cotton, beet, and the like. A preferable raw material of the cellulose fiber may be wood, and may be, for example, pine, cedar, hinoki cypress, eucalyptus, acacia, and the like; besides, paper, used paper, or the like obtained from the aforementioned woods as the raw material can also be used. As for the plant-derived fiber, one type may be used alone, or two or more types selected from the plant-derived fibers may be used.

The cellulose fiber also includes pulp obtained from the raw material containing the plant-derived fiber, a mercerized cellulose fiber, a regenerated cellulose fiber such as rayon, cellophane, lyocell, and the like.

The pulp may be: chemical pulp (unbleached kraft pulp (UKP), bleached kraft pulp (BKP), and sulfite pulp (SP)), semi-chemical pulp (SCP), chemiground pulp (CGP), chemi-mechanical pulp (CMP), ground pulp (GP), refiner mechanical pulp (RMP), thermo-mechanical pulp (TMP), chemi-thermo-mechanical pulp (CTMP), and the like, which are obtained by pulping a plant raw material chemically or mechanically, or in combination of both.

The hydrophobizing agent (a) is a compound having at least one reaction site capable of reacting with the hydroxyl group of the cellulose fiber. By the reaction of the hydrophobizing agent with the hydroxyl group of the cellulose fiber, hydrogen bonding in the cellulose fiber and between the cellulose fibers is inhibited, and the cellulose fiber can be defibrillated to the nano order during kneading. Specific examples of the hydrophobizing agent (a) include, for example, a compound containing a functional group capable of reacting with the hydroxyl group of the cellulose fiber, such as a carboxyl group, an isocyanate group, a halogen group, an epoxy group, a silanol group, an aldehyde group, and the like; acid halide; acid anhydride; and polyvalent basic acid anhydride, wherein acid anhydride, polyvalent basic acid anhydride, and epoxy group-containing compound are preferable in terms of cost and ease of introduction. The hydrophobizing agent (a) can be used alone or in combination of two or more types.

The acid anhydride may be, for example, acetic anhydride, butyric anhydride, propionic anhydride, benzoic anhydride, and stearic anhydride. Among these acid anhydrides, the acetic anhydride is preferable in terms of availability and the ease of

### INTRODUCTION

The polyvalent basic acid anhydride may be, for example, alkyl or alkenyl succinic anhydride, maleic anhydride, phthalic anhydride, succinic anhydride, maleic anhydride-modified polyolefin, maleic anhydride-modified polybutadiene, and the like. Among these acid anhydrides, the alkyl or alkenyl succinic anhydride and the maleic anhydride-modified polybutadiene are preferable from the viewpoint of compatibility with resin.

The epoxy group-containing compound may be, for example, glycidyl ether, glycidyl (meth)acrylate, glycidyl ester, epichlorohydrin, and glycidyl trimethylammonium chloride.

A fixing rate of the hydrophobizing agent (a) to the cellulose fiber is calculated from the following formula.

Fixing rate (%)=(dry mass of modified cellulose fiber (A)−dry mass of cellulose fiber)/(dry mass of cellulose fiber)×100

In terms of a balance between sufficient defibrillation of the fiber during kneading and production cost, the fixing rate in mass ratio is preferably 5 to 50 mass %, and more preferably 5 to 30 mass % with respect to the cellulose fiber. The fixation of the hydrophobizing agent (a) by the chemical bond is confirmed using, for example, a fourier transform infrared spectroscopic method (FT-IR).

<Thermoplastic Resin and/or Rubber (B)>

The thermoplastic resin and/or the rubber (B) used in the present invention is not particularly limited as long as it is a material usually used for molding material applications.

The thermoplastic resin may be: a polyamide resin such as nylon; a polyolefin resin such as polyethylene, polypropylene, an ethylene-propylene copolymer, and an ethylene vinyl acetate copolymer; a polyester resin such as polyethylene terephthalate and polybutylene terephthalate; an acrylic resin such as polymethyl methacrylate and polyethyl methacrylate; a styrene resin such as polystyrene and (meth)acrylic acid ester-styrene resin; other resins such as polyurethane resin, ionomer resin and cellulose resin; a thermoplastic elastomer such as olefin-based elastomer, vinyl chloride-based elastomer, styrene-based elastomer, urethane-based elastomer, polyester-based elastomer and polyamide-based elastomer; and the like. These resins may be a single type or a mixture of two or more types. The polyethylene resin, the polypropylene resin, the polystyrene resin, the ethylene-vinyl acetate resin, and the polyurethane resin are preferable, and the polyethylene resin, the polypropylene resin, and the ethylene-vinyl acetate resin are more preferable.

The rubber may be a diene-based rubber, specifically, natural rubber, butadiene rubber, ethylene-propylene-diene rubber, styrene-butadiene copolymer rubber, isoprene rubber, butyl rubber, acrylonitrile-butadiene rubber, acrylonitrile-styrene-butadiene copolymer rubber, chloroprene rubber, styrene-isoprene copolymer rubber, styrene-isoprene-butadiene copolymer rubber, isoprene-butadiene copolymer rubber, hydrogenated natural rubber, deproteinized natural rubber, and the like. In addition, a rubber component other than a diene-based rubber component may be: ethylene-propylene copolymer rubber, nitrile rubber, acrylic rubber, epichlorohydrin rubber, polysulfide rubber, silicone rubber, fluororubber, urethane rubber, and a mixture of two or more types of these rubbers. The butadiene rubber, the natural rubber, the ethylene-propylene copolymer rubber, and the ethylene-propylene-diene rubber are preferable, and the ethylene-propylene-diene rubber is more preferable.

In addition, the thermoplastic resin and the rubber may be mixed and used in an arbitrary blending ratio according to a required physical property of a molded body.

<Step (i)>

In Step (i), 5 to 45 parts by mass of water is added with respect to 100 parts by mass of the modified cellulose fiber (A) to obtain the hydrous cellulose fiber (A′). The water to be used is not particularly limited, but in order to avoid alteration of the modified cellulose fiber (A), pH of the water is preferably 3 to 11, more preferably 4 to 10, and further preferably 5 to 9.

Although a method for adding water to the modified cellulose fiber (A) is not particularly limited, it is preferable to mix in a container having a stirring machine in order to prevent localization of the water.

The adding amount of the water is required to be 5 to 45 parts by mass with respect to 100 parts by mass of the modified cellulose fiber (A). If the adding amount of the water is less than 5 parts by mass, the effect of the present invention cannot be obtained, and if the adding amount of the water is more than 45 parts by mass, it becomes difficult to remove the water in Step (ii), as a result, problems such as unstable quality or unnecessary water remaining in the obtained resin composition may occur.

A temperature of the modified cellulose fiber (A) when the water is added is preferably 80° C. or lower, more preferably 60° C., and further preferably 40° C. or lower, in order to prevent evaporation of the added water. In addition, in order to prevent the added water from freezing, 0° C. or higher is preferable, and 5° C. or higher is more preferable.

In Step (i), within a range in which the effect of the present invention is not hindered, various additive agents may be blended at the same time, such as a compatibilizing agent, a dispersing agent, a surface active agent, an antioxidizing agent, a flame retardant, a pigment, an inorganic filler, a plasticizing agent, a crystal nucleating agent, a foaming auxiliary, and the like. In addition, within the range in which the effect of the present invention is not hindered, the hydrous cellulose fiber (A′) may be shaped or molded into an easy-to-handle shape, for example, a tablet shape or a plate shape.

<Step (ii)>

In Step (ii), the modified cellulose fiber is defibrillated while the hydrous cellulose fiber (A′) is kneaded with the thermoplastic resin and/or the rubber (B), and the water is removed to attain a water content ratio of 1% or less after kneading to obtain the modified cellulose fiber blended resin composition.

A blending ratio of the hydrous cellulose fiber (A′) and the thermoplastic resin and/or the rubber (B) is not particularly limited, but it is preferable to blend the hydrous cellulose fiber (A′) and the thermoplastic resin and/or the rubber (B) in a mass ratio of (A′)/(B)=105 to 145/100 to 250, from the viewpoints of a necessary cellulose content ratio for obtaining a target strength in the molded body using the modified cellulose fiber blended resin composition and ease of defibrillation of the cellulose fiber during kneading.

Equipment used for kneading is a uniaxial or multiaxial kneading machine, but the multiaxial kneading machine is preferable because the cellulose fiber is defibrillated while kneaded with a resin, and a biaxial kneading machine is more preferable from the viewpoint of the equipment. The kneading machine may be a batch type or a continuous type, and preferably has equipment capable of removing the water in the hydrous cellulose fiber (A′), a vent hole, and the like.

A temperature during kneading is preferably a temperature at which the water in the (A′) can be removed and the cellulose fiber is not deteriorated by heat. Specifically, it is preferable to knead within a range of 100 to 200° C.

The modified cellulose fiber (A) may be defibrillated to a nanofiber in an extent that the desired physical property is obtained in the molding material after kneading. Here, the nanofiber usually means a cellulose fiber defibrillated to an average fiber diameter of 4 to 800 nm. In the present invention, if no visually recognizable coarse particles of 0.5 mm or more are visible in a press film made for confirmation of a defibrillation state, the cellulose fiber is considered to be sufficiently nano-sized and uniformly dispersed.

The water in the obtained modified cellulose fiber blended resin composition is preferably removed to 1% or less during kneading. If the water remains in the final composition, the deterioration in quality may easily occur, such as coloring over time and the like.

In Step (ii), as in Step (i), within the range in which the effect of the present invention is not hindered, various additive agents may be blended at the same time, such as a compatibilizing agent, a dispersing agent, a surface active agent, an antioxidizing agent, a flame retardant, a pigment, an inorganic filler, a plasticizing agent, a crystal nucleating agent, a foaming auxiliary, and the like.

The thus obtained modified cellulose fiber blended resin composition can be formed into a desired molded body by adding various additive agents according to the application to be used and molding.

### EXAMPLE

Examples of the present invention are described below. Moreover, the present invention is not limited to the examples. Moreover, unless otherwise specified, “part” means “part by mass”.

<Physical Property Value Measurement Method>

Physical property value measurement methods used in some of the examples are as follows.

Calculation of fixing rate of hydrophobizing agent (a) to cellulose fiber

The fixing rate is calculated by the following formula.

Fixing rate (%)=(dry mass of modified cellulose fiber (A)−dry mass of cellulose fiber)/(dry mass of cellulose fiber)×100

In addition, the dry mass of the modified cellulose fiber (A) is measured by the following method. A dispersion liquid is prepared by adding 100 times mass of tetrahydrofuran to the total amount of the modified cellulose fiber (A) obtained by methods of manufacturing examples 1 to 4, and is stirred for one minute at 10000 rpm by a homogenizer (manufactured by NIHONSEIKI KAISHA Ltd.), and then the dispersion liquid is suction-filtered. The filtration residue is dried in an electric drying machine at 110° C., and the dry mass is measured.

A fourier transformation infrared spectrophotometer (manufactured by JASCO Corporation) is used to confirm the fixation of the hydrophobizing agent (a) to the cellulose by the chemical bond. In the modified cellulose fiber (A) whose dry mass is measured, an absorption spectrum which is not found in the unmodified cellulose fiber is observed at 1500 to 2000 cm⁻¹.

Calculation of water content ratio of modified cellulose fiber blended resin composition

5 g of the modified cellulose fiber blended resin composition obtained in Step (ii) immediately after kneading is taken to precisely weigh the mass before drying. Then, the modified cellulose fiber blended resin composition dried in the electric drying machine for 30 minutes at 150° C. and then cooled in a desiccator for 15 minutes is precisely weighed as the mass after drying, and the water content ratio is calculated by the following formula.

Water content ratio (%)=[(mass before drying)−(mass after drying)]/(mass before drying)×100

Confirmation of Defibrillation State

0.5 g of the modified cellulose fiber blended resin composition obtained in the examples and comparative examples is taken to make a press film using a hot-pressing machine (manufactured by AS ONE Corporation) with a pressure of 20 MPa at 190° C. for a polypropylene resin composition and 20 MPa at 160° C. for other resin compositions. The modified cellulose fiber blended resin composition in which the coarse grains of 0.5 mm or more are visually visible in the press film is marked with “X”, and the modified cellulose fiber blended resin composition in which the coarse grains of 0.5 mm or more are invisible in the press film is marked with “0”.

Confirmation of Color

5 g of the modified cellulose fiber blended resin composition obtained in the examples and the comparative examples is taken to make a total of four press films with a thickness of 1 mm using a hot-pressing machine with a pressure of 10 MPa at 190° C. for the polypropylene resin composition and 10 MPa at 160° C. for other resin compositions. The press films are superimposed and a brightness (L*) is measured using a colorimeter (CM-600d manufactured by KONICA MINOLTA, Inc.). A relative value of the color is calculated using the following formula.

Relative value of color=(L*of resin composition obtained by manufacturing method containing water)/(L*of resin composition obtained by manufacturing method not containing water)×100

The formula indicates that the higher the relative value of the color, the brighter the color and the higher the degree of improvement.

<Manufacture of Modified Cellulose Fiber (A)>

### Manufacturing Example 1

500 parts by mass of needle-leaved tree bleached kraft pulp (NBKP) with a solid content of 20 mass % and 150 parts by mass of N-methylpyrrolidone (NMP) are placed in a clean container, the water is distilled away by decompression, then 19.9 parts by mass of hexadecenylsuccinic anhydride are put into the container, and a reaction is performed at 80° C. for four hours. After the reaction, the NMP is distilled away by decompression, and a modified cellulose fiber (A-1) is obtained. The fixing rate of the hydrophobizing agent (a) is 8.6%.

### Manufacturing Example 2

500 parts by mass of needle-leaved tree bleached kraft pulp (NBKP) with a solid content of 20 mass % and 150 parts by mass of N-methylpyrrolidone (NMP) are placed in a clean container, the water is distilled away by decompression, then 300 parts by mass of acetic anhydride are put into the container, and a reaction is performed at 80° C. for four hours. After the reaction, the NMP is distilled away by decompression, and a modified cellulose fiber (A-2) is obtained. The fixing rate of the hydrophobizing agent (a) is 14.2%.

### Manufacturing Example 3

500 parts by mass of needle-leaved tree bleached kraft pulp (NBKP) with a solid content of 20 mass % and 150 parts by mass of N-methylpyrrolidone (NMP) are placed in a clean container, the water is distilled away by decompression, then 19.9 parts by mass of the hexadecenylsuccinic anhydride is put into the container, and a reaction is performed at 80° C. for four hours. Next, 10 parts by mass of glycidyl methacrylate is added and a reaction is performed at 130° C. for three hours. After the reaction, the NMP is distilled away by decompression, and a modified cellulose fiber (A-3) is obtained. The fixing rate of the hydrophobizing agent (a) is 16.0%.

### Manufacturing Example 4

500 parts by mass of needle-leaved tree bleached kraft pulp (NBKP) with a solid content of 20 mass % and 150 parts by mass of N-methylpyrrolidone (NMP) are placed in a clean container, the water is distilled away by decompression, then 35 parts by mass of maleic anhydride-modified polybutadiene is put into the container, and a reaction is performed at 80° C. for four hours. After the reaction, the NMP is distilled away by decompression, and a modified cellulose fiber (A-4) is obtained. The fixing rate of the hydrophobizing agent (a) is 28.0%.

Moreover, unmodified needle-leaved tree pulp (NBKP) is dried and solidified to obtain an “unmodified cellulose” (A-5) for comparison.

TABLE 1

| (Un)modified | | | Fixing rate of |
|---|---|---|---|
| cellulose | Cellulose | Hydrophobizing | hydrophobizing |
| fiber (A) | fiber | agent (a) | agent (a) (%) |
| A-1 | NBKP | Hexadecenylsuccinic | 8.6 |
| | | anhydride | |
| A-2 | NBKP | Acetic anhydride | 14.2 |
| A-3 | NBKP | Hexadecenylsuccinic | 16.0 |
| | | anhydride | |
| | | Glycydyl methacrylate | |
| A-4 | NBKP | Maleic anhydride- | 28.0 |
| | | modified polybutadiene | |
| A-5 | NBKP | — | 0 |

<Blend with Polyethylene Resin>

### Example 1

Step (i)

100 parts by mass of the modified cellulose fiber (A-1) and 7.5 parts by mass of water were added into a container equipped with a stirring machine, and the mixture was stirred at 1500 rpm for 15 minutes to obtain a hydrous cellulose fiber (A′-1-1).

Step (ii)

107.5 parts by mass of the hydrous cellulose fiber (A′-1-1) and 150 parts by mass of a polyethylene resin (B-1: ULTZEX(registered trademark) 4020L, manufactured by Prime Polymer Co., Ltd.) were kneaded at 170° C. while the pressure was reduced in a biaxial extrusion machine (with a diameter of 15 mm, L/D=45, manufactured by TECHNOVEL Corporation), and a modified cellulose fiber blended resin composition was obtained. The water content ratio in the obtained modified cellulose fiber blended resin composition was 0.2%.

### Example 2

The modified cellulose fiber used in Step (i) of Example 1 was changed to the (A-2), and the amount of the water added was changed to 31 parts by mass, thereby obtaining a hydrous cellulose fiber (A′-2-1). Furthermore, the same operations as in Example 1 were performed to obtain a modified cellulose fiber blended resin composition except that the hydrous cellulose fiber used in Step (ii) was changed to 131 parts by mass of the (A′-2-1). The water content ratio in the obtained modified cellulose fiber blended resin composition was 0.3%.

### Example 3

The modified cellulose fiber used in Step (i) of Example 1 was changed to the (A-2), and the amount of the water added was changed to 11 parts by mass, thereby obtaining a hydrous cellulose fiber (A′-2-2). Furthermore, the same operations as in Example 1 were performed to obtain a modified cellulose fiber blended resin composition except that the hydrous cellulose fiber used in Step (ii) was changed to 111 parts by mass of the (A′-2-2). The water content ratio in the obtained modified cellulose fiber blended resin composition was 0.2%.

### Example 4

The modified cellulose fiber used in Step (i) of Example 1 was changed to the (A-3), and the amount of the water added was changed to 11 parts by mass, thereby obtaining a hydrous cellulose fiber (A′-3-1). Furthermore, the same operations as in Example 1 were performed to obtain a modified cellulose fiber blended resin composition except that the hydrous cellulose fiber used in Step (ii) was changed to 111 parts by mass of the (A′-3-1). The water content ratio in the obtained modified cellulose fiber blended resin composition was 0.3%.

### Example 5

The modified cellulose fiber used in Step (i) of Example 1 was changed to the (A-3), and the amount of the water added was changed to 42 parts by mass, thereby obtaining a hydrous cellulose fiber (A′-3-2). Furthermore, the same operations as in Example 1 were performed to obtain a modified cellulose fiber blended resin composition except that the hydrous cellulose fiber used in Step (ii) was changed to 142 parts by mass of the (A′-3-2). The water content ratio in the obtained modified cellulose fiber blended resin composition was 0.5%.

### Comparative Example 1

The modified cellulose fiber used in Step (i) of Example 1 was changed to the unmodified needle-leaved tree kraft pulp (NBKP) (A-5), and the amount of the water added was changed to 30 parts by mass, thereby obtaining a hydrous cellulose fiber (A′-5-1). Furthermore, the same operations as in Example 1 were performed to obtain an unmodified cellulose fiber blended resin composition except that the hydrous cellulose fiber used in Step (ii) was changed to 130 parts by mass of the (A′-5-1). The water content ratio in the unmodified cellulose fiber blended resin composition was 0.5%.

### Comparative Example 2

The same operations as in Example 1 were performed to obtain a modified cellulose fiber blended resin composition except that 100 parts by mass of the modified cellulose fiber (A-1) was used directly without adding water in Step (i) of Example 1. The water content ratio in the obtained modified cellulose fiber blended resin composition was 0%.

TABLE 2

| | Kneading composition of Step (ii) | | | | | | | |
|---|---|---|---|---|---|---|---|---|
| | | | | | Thermo- | | | |
| | (Hydrous) cellulose fiber (A′) | | | | plastic | (Modified) cellulose fiber | | |
| | | (Modified) | | | resin | blended resin composition | | |
| | | cellulose fiber (A) | | Water | (B-1) | Water | Defi- | |
| | | | Part | Part | Part | content | bril- | Relative |
| | | | by | by | by | ratio | lation | value of |
| | | | mass | mass | mass | (%) | state | color |
| Example 1 | A′-1-1 | A-1 | 100 | 7.5 | 150 | 0.2 | ◯ | 142 |
| Example 2 | A′-2-1 | A-2 | 100 | 31 | 150 | 0.3 | ◯ | 200 |
| Example 3 | A′-2-2 | A-2 | 100 | 11 | 150 | 0.2 | ◯ | 175 |
| Example 4 | A′-3-1 | A-3 | 100 | 11 | 150 | 0.3 | ◯ | 167 |
| Example 5 | A′-3-2 | A-3 | 100 | 42 | 150 | 0.5 | ◯ | 191 |
| Comparative | A′-5-1 | A-5 | 100 | 30 | 150 | 0.5 | X | — |
| example 1 | | | | | | | | |

| | | | | | | | |
|---|---|---|---|---|---|---|---|
| Comparative | A-1 | 100 | 0 | 150 | 0 | ◯ | 100 |
| example 2 | | | | | | | |

<Blend with Ethylene-Vinyl Acetate Resin>

### Example 6

Step (i) 100 parts by mass of the modified cellulose fiber (A-3) and 11 parts by mass of water were added into a container equipped with a stirring machine and the mixture was stirred at 1500 rpm for 15 minutes to obtain a hydrous cellulose fiber (A′-3-1).

Step (ii)

111 parts by mass of the hydrous cellulose fiber (A′-3-1) and 233 parts by mass of an ethylene-vinyl acetate resin (B-2: Ultrathene® 635, manufactured by TOSOH Corporation) were kneaded at 170° C. while the pressure was reduced in a biaxial extrusion machine (with a diameter of 15 mm, L/D=45, manufactured by TECHNOVEL Corporation), and a modified cellulose fiber blended resin composition was obtained. The water content ratio in the obtained modified cellulose fiber blended resin composition was 0.1%.

### Comparative Example 3

The same operations as in Example 6 were performed to obtain a modified cellulose fiber blended resin composition except that 100 parts by mass of the modified cellulose fiber (A-3) was used directly without adding water in Step (i) of Example 6. The water content ratio in the obtained modified cellulose fiber blended resin composition was 0%.

TABLE 3

| | Kneading composition of Step (ii) | | | | | | | |
|---|---|---|---|---|---|---|---|---|
| | | | | | Thermo- | | | |
| | (Hydrous) cellulose fiber (A′) | | | | plastic | (Modified) cellulose fiber | | |
| | | (Modified) | | | resin | blended resin composition | | |
| | | cellulose fiber (A) | | Water | (B-2) | Water | Defi- | |
| | | | Part | Part | Part | content | bril- | Relative |
| | | | by | by | by | ratio | lation | value of |
| | | | mass | mass | mass | (%) | state | color |
| Example 6 | A′-3-1 | A-3 | 100 | 11 | 233 | 0.1 | ◯ | 131 |

| | | | | | | | |
|---|---|---|---|---|---|---|---|
| Comparative | A-3 | 100 | 0 | 233 | 0 | ◯ | 100 |
| example 3 | | | | | | | |

<Blend with Polypropylene Resin>

### Example 7

Step (i)

100 parts by mass of the modified cellulose fiber (A-1) and 30 parts by mass of water were added into a container equipped with a stirring machine and the mixture was stirred at 1500 rpm for 15 minutes to obtain a hydrous cellulose fiber (A′-1-2).

Step (ii)

130 parts by mass of the hydrous cellulose fiber (A′-1-2) and 100 parts by mass of a polypropylene resin (B-3: BC03B, manufactured by Japan Polypropylene Corporation) were kneaded at 170° C. while the pressure was reduced in a biaxial extrusion machine (with a diameter of 15 mm, L/D=45, manufactured by TECHNOVEL Corporation), and a modified cellulose fiber blended resin composition was obtained. The water content ratio in the obtained modified cellulose fiber blended resin composition was 0.4%.

### Comparative Example 4

The same operations as in Example 7 were performed to obtain a modified cellulose fiber blended resin composition except that 100 parts by mass of the modified cellulose fiber (A-1) was used directly without adding water in Step (i) of Example 7. The water content ratio in the obtained modified cellulose fiber blended resin composition was 0%.

TABLE 4

| | Kneading composition of Step (ii) | | | | | | | |
|---|---|---|---|---|---|---|---|---|
| | | | | | Thermo- | | | |
| | (Hydrous) cellulose fiber (A′) | | | | plastic | (Modified) cellulose fiber | | |
| | | (Modified) | | | resin | blended resin composition | | |
| | | cellulose fiber (A) | | Water | (B-3) | Water | Defi- | |
| | | | Part | Part | Part | content | bril- | Relative |
| | | | by | by | by | ratio | lation | value of |
| | | | mass | mass | mass | (%) | state | color |
| Example 7 | A′-1-2 | A-1 | 100 | 30 | 100 | 0.4 | ◯ | 110 |

| | | | | | | | |
|---|---|---|---|---|---|---|---|
| Comparative | A-1 | 100 | 0 | 100 | 0 | ◯ | 100 |
| example 4 | | | | | | | |

<Blend with Ethylene-Propylene-Diene Rubber>

### Example 8

Step (i)

100 parts by mass of the modified cellulose fiber (A-4) and 5 parts by mass of water were added into a container equipped with a stirring machine and the mixture was stirred at 1500 rpm for 15 minutes to obtain a hydrous cellulose fiber (A′-4-1).

Step (ii)

105 parts by mass of the hydrous cellulose fiber (A′-4-1) and 100 parts by mass of an ethylene-propylene-diene rubber (B-4: EP24, manufactured by JSR Corporation) were kneaded at 140° C. in a batch-type kneading machine Labo Plastomill (manufactured by TOYOSEIKI Co., Ltd.) to obtain a modified cellulose fiber blended resin composition. The water content ratio in the obtained modified cellulose fiber blended resin composition was 0.1%.

### Comparative Example 5

The same operations as in Example 8 were performed to obtain a modified cellulose fiber blended resin composition except that 100 parts by mass of the modified cellulose fiber (A-4) was used directly without adding water in Step (i) of Example 8. The water content ratio in the obtained modified cellulose fiber blended resin composition was 0%.

TABLE 5

| | Kneading composition of Step (ii) | | | | | | | |
|---|---|---|---|---|---|---|---|---|
| | (Hydrous) cellulose fiber (A′) | | | | | (Modified) cellulose fiber | | |
| | | (Modified) | | | Rubber | blended resin composition | | |
| | | cellulose fiber (A) | | Water | (B-4) | Water | Defi- | |
| | | | Part | Part | Part | content | bril- | Relative |
| | | | by | by | by | ratio | lation | value of |
| | | | mass | mass | mass | (%) | state | color |
| Example 8 | A′-4-1 | A-4 | 100 | 5 | 100 | 0.1 | ◯ | 133 |

| | | | | | | | |
|---|---|---|---|---|---|---|---|
| Comparative | A-4 | 100 | 0 | 100 | 0 | ◯ | 100 |
| example 5 | | | | | | | |

It is shown that according to the manufacturing method of the present invention, the color after manufacturing is improved as compared with a conventional manufacturing method. In addition, it is indicated that the effect of the present invention is achieved with various thermoplastic resins and rubbers.

1. A method for manufacturing a modified cellulose fiber blended resin composition, comprising:
(i) a step of adding 5 to 45 parts by mass of water with respect to 100 parts by mass of a cellulose fiber (A) modified with a hydrophobizing agent (a) to obtain a hydrous cellulose fiber (A′); and
(ii) a step of defibrillating the modified cellulose fiber while kneading the hydrous cellulose fiber (A′) with a thermoplastic resin and/or a rubber (B), and removing the water to attain a water content ratio of 1% or less after kneading.

2. The method for manufacturing a modified cellulose fiber blended resin composition according to claim 1, wherein the cellulose fiber (A) modified with the hydrophobizing agent (a) in which a fixing rate of the hydrophobizing agent (a) to the cellulose fiber is 5 to 50 mass % with respect to the cellulose fiber is used.

3. The method for manufacturing a modified cellulose fiber blended resin composition according to claim 1, wherein the hydrophobizing agent (a) is at least one type selected from acid anhydrides and derivatives thereof.

4. The method for manufacturing a modified cellulose fiber blended resin composition according to claim 1, wherein the hydrous cellulose fiber (A′) and the thermoplastic resin and/or the rubber (B) are blended in a manner that a mass ratio is (A′)/(B)=105 to 145/100 to 250.

5. The method for manufacturing a modified cellulose fiber blended resin composition according to claim 1, wherein the thermoplastic resin and/or the rubber (B) is at least one type selected from polyethylene resin, polypropylene resin, polystyrene resin, ethylene-vinyl acetate resin, and ethylene-propylene-diene rubber.

6. The method for manufacturing a modified cellulose fiber blended resin composition according to claim 1, wherein the cellulose fiber (A) modified with the hydrophobizing agent (a) is defibrillated to a nanofiber in Step (ii).
